(19) United States
(12) Patent Application Publication
(10) Pub. No.: US 2007/0002830 A1
(43) Pub. Date: Jan. 4, 2007

(54) Integrating telephonic service providers

(75) Inventor: David Scott Beckemeyer, Danville, CA (US)

Correspondence Address: SMITH FROHWEIN TEMPEL GREENLEE BLAHA, LLC, P.O. BOX 88148, ATLANTA, GA, 30356, US

(73) Assignee: TelEvolution Incorporated

(21) Appl. No.: 11/157,643

(22) Filed: Jun. 21, 2005

(51) Int. Cl. H04L 12/66

(52) U.S. Cl. 370/352

(57) ABSTRACT

A system for integrating telephonic service providers to subscribers of a voice-over-Internet service comprises a device interface, a voice-over-Internet platform, and a provider interface. The device interface enables a communication link over an existing telephone service and a data network to a subscriber voice-over-Internet device. The voice-over-Internet platform links or binds a telephone number associated with the existing telephone service to a unique identifier associated with the subscriber voice-over-Internet device. The provider interface exposes the voice-over-Internet platform and thus the subscribers to a service provider. As a result, a landline or wireless telephone service customer can subscribe to services provided by the service provider without the knowledge or permission of the telephone service company.

### CROSS-REFERENCE TO RELATED APPLICATIONS

This application is related to co-pending U.S utility patent application entitled “Telephone Number Binding in a Voice-Over-Internet System,” filed on Oct. 13, 2004 and accorded application Ser. No. 10/964,518, which is incorporated by reference herein in its entirety.

### BACKGROUND OF THE INVENTION

1. Field of the Invention

Systems and methods that relate generally to the provision of telephonic services are invented and disclosed.

2. Related Art

Presently, there are a number of solutions that enable customers to place telephone calls over the Internet, rather than over the public-switched telephone network (PSTN). Internet telephony services (e.g., voice-over-Internet-Protocol (VoIP), voice-over-digital-subscriber-line (VoDSL), voice-over-asynchronous-transfer-mode (VoATM), etc.) have become much more prevalent as the number of broadband connections at residential locations has increased.

One of the earliest Internet telephony solutions is a “soft phone.” A soft phone is computer software that may be installed on a typical personal computer. The computer software enables any computer device with a speaker and a microphone to place free Internet calls through an Internet service provider (ISP). Soft phones, however, suffer from various disadvantages and problems. For example, in many cases, soft phones only enable a user to make free Internet calls to other users that have installed the same or similar software on their computer. Furthermore, these software-based solutions offer no or limited calling to the PSTN.

Another Internet telephony solution employs service providers (e.g., Internet telephone service providers (ITSP)) that offer voice-over-Internet services to subscribers. An ITSP usually provides the subscribers with supporting hardware. The supporting hardware may comprise a stand-alone device manufactured by another company (e.g., a VoIP phone) that connects to the Internet. The supporting hardware, software, etc. may also be other equipment that functions as an interface between the customer's standard telephone and the Internet. Typically, the ITSP sells or leases the hardware to the subscriber and charges the customer a monthly service fee for the services. In some cases, the potential subscriber may purchase the hardware from another entity and then request service from the ITSP.

ITSP solutions also have a number of disadvantages. Many customers have been slow to adopt this approach because they are unwilling to abandon the familiar expectations of their traditional phone service. For example, a number of alarm systems, satellite television, and other services rely on a connection to the PSTN. The PSTN typically functions even through widespread electrical service outages. The PSTN is not adversely affected by ISP or ITSP service outages. More importantly, emergency calls accessed by dialing “911” from a VoIP solution often do not provide the emergency operator with information that can be used to locate the caller.

Another problem associated with VoIP services is associated with the business model that VoIP service providers have used to market their product. The common business model in VoIP services is a “landline replacement” model, in which service providers attempt to mimic the traditional PSTN service. Users are expected to replace their traditional PSTN service for the lower fee offered by the ITSP for long-distance and other services. Thus, customers with traditional alarm, satellite television, and other services that use the PSTN will be slow to adopt an additional service absent a compelling economic reason.

Accordingly, despite the growth of Internet telephony services and products there is still a need for improved voice-over-Internet solutions.

### SUMMARY

An embodiment of a system for integrating telephonic service providers to subscribers of a voice-over-Internet service comprises a device interface, a voice-over-Internet platform, and a provider interface. The device interface provides a communication link over an existing telephone service medium and a data network to a subscriber voice-over-Internet device. The subscriber voice-over-Internet device is configured to process plain old telephone service calls and wireless service calls as voice-over-Internet calls. The voice-over-Internet platform links or binds a telephone number associated with the existing telephone service to a unique identifier associated with the subscriber voice-over-Internet device. The provider interface exposes the subscriber voice-over-Internet device via the voice-over-Internet platform to a service provider.

Related methods are also provided. An embodiment of a method for integrating telephonic service providers to subscribers of a voice-over-Internet service comprises providing a voice-over-Internet platform configured to link a telephone number associated with an existing telephone service to a unique identifier associated with a subscriber voice-over-Internet device, wherein the subscriber voice-over-Internet device is configured to process plain old telephone service calls and wireless service calls as voice-over-Internet calls and providing an interface configured to expose the subscriber voice-over-Internet device via the voice-over-Internet platform to one or more service providers.

A method for exposing telephonic service subscribers to service providers is also invented and disclosed. The method comprises providing a subscriber VoI device at the edge between both the public switched telephone network, a wireless network, and a wide-area data network and a telephonic device coupled to the subscriber VoI device at a subscriber premise, providing a VoI platform coupled to an existing telephone service and the wide-area data network, the VoI platform comprising a device interface that defines mechanisms for configuring and operating the subscriber VoI device at the subscriber premise, a provider interface that defines mechanisms for service provider communications with the VoI platform, and a data network interface, and leveraging the combination of the subscriber VoI device and the VoI platform to create a service provider-to-subscriber channel that bypasses a plain old telephone system service provider and enables a service provider to promote and enable telephonic services operable at the telephonic device.

Other features and advantages of the systems and methods for integrating telephonic service providers to subscribers of a voice-over-Internet service will be or become apparent to one with skill in the art upon examination of the following figures and detailed description. All such additional features and advantages are within the scope of the systems and methods for integrating telephonic service providers as protected by the accompanying claims.

### BRIEF DESCRIPTION OF THE FIGURES

The systems and methods for integrating telephonic service providers with subscribers can be better understood with reference to the following figures. The components within the figures are not necessarily to scale, emphasis instead being placed upon clearly illustrating the principles of integrating third-party service providers with telephonic service subscribers via an integration platform coupled to a data network. Moreover, in the figures, like reference numerals designate corresponding parts throughout the different views.

FIG. 1 is a block diagram illustrating an embodiment of a system for integrating telephonic service providers to subscribers of a service.

FIG. 2 is a block diagram illustrating an embodiment of the provider interface of FIG. 1.

FIG. 3 is a functional block diagram of an embodiment of a subscriber voice-over-Internet device of the system of FIG. 1.

FIG. 4 is a functional block diagram illustrating an embodiment of the voice-over-Internet platform of FIG. 1.

FIG. 5 is a schematic diagram illustrating the linking of a telephone number to a subscriber voice-over-Internet device identifier by the voice-over-Internet platform of FIG. 1.

FIG. 6 is a schematic diagram illustrating an embodiment of an operational environment in which the integration system of FIG. 1 and the subscriber voice-over-Internet device of FIG. 3 enable landline or wireless phone service customers to subscribe to services from non-traditional service providers.

FIG. 7 is a flow diagram illustrating an embodiment of a method for integrating telephonic service providers with voice-over-Internet subscribers that can be implemented by the system of FIG. 1 and the subscriber voice-over-Internet device of FIG. 3.

FIG. 8 is a flow diagram illustrating an alternative embodiment of a method for integrating telephonic service providers with voice-over-Internet subscribers that can be implemented by the system of FIG. 1 and the subscriber voice-over-Internet device of FIG. 3.

FIG. 9 is a flow diagram illustrating an embodiment of a method for exposing telephonic service subscribers to service providers that can be implemented by the system of FIG. 1 and the subscriber voice-over-Internet device of FIG. 3.

### DETAILED DESCRIPTION

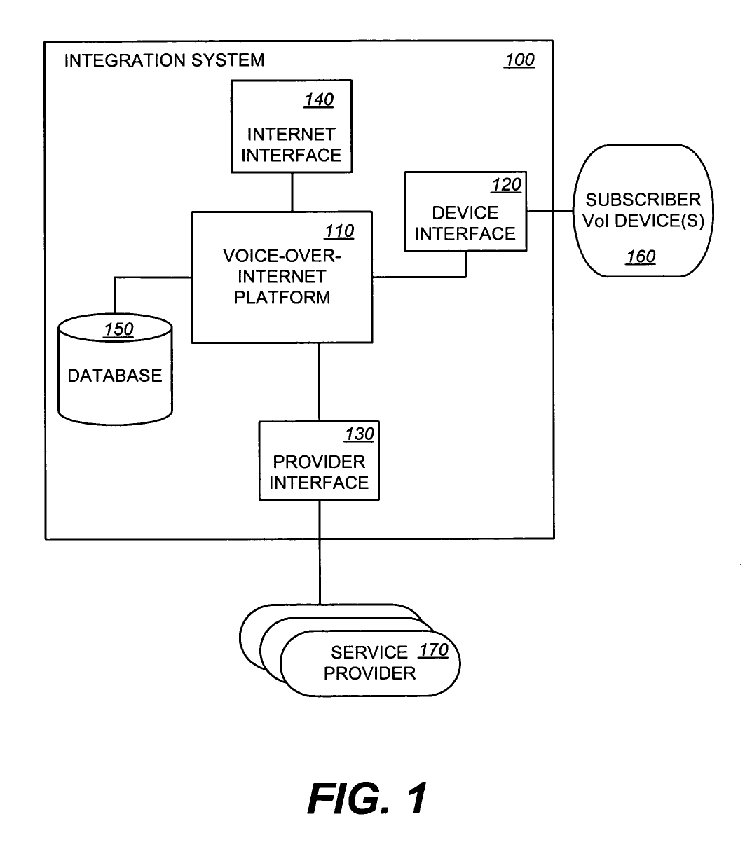

Various embodiments of telecommunication systems, methods, and computer programs, etc. that combine a subscriber voice-over-Internet device located within a subscriber premise with a remotely located voice-over-Internet platform to expose subscribers to add-on services created by telephonic service providers will be described with respect to FIGS. 1-9. As an introductory matter, however, an exemplary embodiment of an integration system for providing add-on services to subscribers of POTS and broadband-data services will be briefly described. With regard to all described embodiments, it should be appreciated that the term “voice-over-Internet” is not limited to any particular protocol, transmission medium, communications network, topology, architecture, etc. Rather, “voice-over-Internet” applies to any system that supports telephone calls between two or more individuals via a data network. By way of example, voice-over-Internet (VoI) should be construed to include existing and future Internet telephony services, such as voice-over-Internet-Protocol (VoIP), voice-over-digital-subscriber-line (VoDSL), voice-over-asynchronous-transfer-mode (VoATM), etc. Furthermore, it should be appreciated that the voice services need not be provided over a public network but, rather, may also be provided over a private network, such as a local area network, wide area network, etc., to name a few examples.

The exemplary integration system for providing VoI services comprises a VoI platform which supports communications with one or more subscriber VoI devices located at the subscriber premise. The subscriber VoI device communicates with other destination devices using both a phone service provider via a traditional telephone landline or a wireless service and a broadband data service provider, such as an Internet service provider. The subscriber VoI device is configured to connect traditional POTS calls via the POTS service provider to a telephonic device coupled to the PSTN. The VoI device is also configured to interface with a docking station for a cellular phone, or via a Bluetooth interface to a cellular service. The subscriber VoI device is also configured to connect VoI calls via the data network with similarly configured telephonic devices. The subscriber VoI device is a plug-n-play device. That is, once the subscriber has connected the device and starts to make calls, the combination of the VoI platform and subscriber VoI device work together to provision the subscriber VoI device. The subscriber VoI device is well-suited for distribution and marketing through consumer electronic retailers.

Once a communication session is established, the subscriber VoI device processes both POTS, cellular, and VoI calls as if the calls are VoI calls. Thus, an appropriately configured subscriber VoI device can provide VoIP like add-on services that are operable even when a present call is being communicated from the subscriber VoI device to a destination device over a cellular network or the PSTN.

The subscriber VoI device is configured to monitor PSTN and cellular calls initiated from the subscriber premise to determine if a similarly configured device is handling the call at the destination. When it is the case that a similarly configured device is identified on the other end of a call, the subscriber VoI device is configured to retrieve and store a device identifier that is linked or bound to the destination number. Once the link has been established, future calls to the similarly configured device can be initiated and routed over the data network when the data network is available. When the data network is not available, the subscriber VoI device initiates and completes the call via the PSTN, a cellular network, or a combination of the PSTN and cellular network. The subscriber VoI device is further configured to handle incoming cellular and PSTN calls. Add-on services can be controllably activated for such calls. For example, if a subscriber has elected to subscribe to caller-id and telemarketer screening services, the VoI device will interrupt the ring tone to the subscriber's telephone when an incoming call does not include caller-id information. If the calling party responds appropriately to a prompt from the system, the call will be forwarded to the subscriber's telephone. Otherwise, the call is terminated and the subscriber is prevented from having to answer a call from a possible telemarketer.

From the subscriber's perspective, the subscriber VoI device is a black-box device that may be easily configured (and, in some embodiments, automatically configured) for communication with the VoI platform. After the device is provisioned, the subscriber may initiate telephone calls to other individuals without regard to whether the call is being placed over the PSTN, a cellular network, or the data network. The subscriber VoI device and the VoI platform perform the logical functions necessary to support standard PSTN telephone calls, cellular calls, and VoI calls.

A provisioning process may be initiated which configures the subscriber VoI device for VoI service. The provisioning process may be initiated by the subscriber, the subscriber VoI device, or the VoI platform. During the provisioning process, the subscriber's existing telephone number is provided to the VoI platform. As described below, the existing telephone number is used by the VoI platform as a terminating identifier during the provisioning of VoI and/or PSTN services. In this manner, the existing telephone number may be used to make VoI calls to the corresponding subscriber VoI device. Therefore, rather than having to assign a new terminating identifier, the VoI platform may use the existing telephone number as the terminating identifier. A similar provisioning process can be applied to calls enabled over a cellular network.

It should be appreciated that the existing telephone number may be provided to the VoI platform in a number of ways. For example, in one embodiment, the existing telephone number may be automatically provided to the VoI platform by the subscriber VoI device, either via the data network or the PSTN. In alternative embodiments, the subscriber may provide the existing telephone number to the VoI platform. The VoI platform may support an interactive voice response (IVR) system by which the subscriber interactively supplies the existing telephone number. The VoI platform may also support a web-based (or other data) channel via the data network, which enables the subscriber, the subscriber VoI device, or a combination thereof to provide the existing telephone number to the VoI platform.

Although not necessary, in certain embodiments, the VoI platform may also provide a means for authenticating the telephone number provided, in order to confirm that the telephone number is in fact within the control of the subscriber VoI device. Without any authentication process, it may be possible for a subscriber to usurp someone else's phone number. Therefore, in certain embodiments, it may be desirable to employ a reliable and accurate authentication scheme to validate the telephone number provided. The authentication mechanism may be fully automated via data and/or PSTN connections between the subscriber VoI device and the VOI platform. In some embodiments, at least portions of the authentication scheme may involve interactive or manual input from the subscriber, rather than the subscriber VoI device.

One embodiment of a provisioning method or process may be fully automated in order to minimize (or completely avoid) any burdensome user interaction with the subscriber VoI device or the VoI platform. The communications between the VoI platform and the subscriber VoI device occur via parallel PSTN and data connections. The subscriber connects the subscriber VoI device to a telephone line or a cellular service and a data network. The subscriber VoI device establishes communication with the VoI platform via the data network. The subscriber VoI device transmits a unique device identifier stored in memory to the VoI platform via the data network. The VoI platform may verify the subscriber VoI device based on the unique device identifier. If the device is verified, the VoI platform may generate a unique session identifier for the data connection. The VoI platform instructs the subscriber VoI device (via the data network) to make a telephone call to a predetermined telephone number, which terminates at the VoI platform. The subscriber VoI device initiates the telephone call over the PSTN or alternatively, a cellular network, to the predetermined telephone number. When the VoI platform receives the call from the subscriber VoI device, the subscriber's telephone number may be identified through the automatic number identification (ANI) service provided by the supporting telephone service provider. Via the data network, the VoI platform may then instruct the subscriber VoI device to transmit the session identifier over the telephone call (e.g., using dual-tone multi-frequency (DTMF) digits). The VoI platform compares the transmitted information to the session identifier for the data connection to confirm the identity of the subscriber VoI device. If the correct session identifier is received by the VoI platform, the VoI platform may authenticate the subscriber VoI device and link the subscriber VoI device to the corresponding telephone number.

It should be appreciated that additional and/or alternative schemes may be employed to confirm that the telephone number is within the control of the subscriber VoI device as deemed appropriate by particular system providers, for particular applications or subscribers, etc. Furthermore, it should be appreciated that the authentication request(s) may be submitted to the subscriber VoI device via the data channel or a telephone service connection. In the embodiment described above, the call-to-platform request and the transmit-session-identifier request initiated by the VoI platform are performed via the data session and the corresponding actions or responses from the subscriber VoI device are provided via the PSTN. One of ordinary skill in the art will appreciate that the closed-loop authentication scheme may be reversed so that the requests from the VoI platform are made via the PSTN and the subscriber VoI device responds via the data session.

Regardless of the authentication scheme (or whether an authentication scheme is even performed), the VoI platform associates (e.g., links, binds, relates, etc.) the existing telephone number to the subscriber VoI device. In this manner, the VoI platform may develop and maintain a database containing information that links a particular subscriber VoI device to the existing telephone number. The association between the existing telephone number and the subscriber VoI device enables the VoI platform to establish VoI calls between subscribers. For example, when a calling subscriber associated with a first subscriber VoI device attempts to place a call to a particular telephone number, the VoI platform may determine whether the subscriber at that particular telephone number has been provisioned by the VoI platform. The VoI platform may access the database and determine whether the telephone number has been associated with a second subscriber VoI device. If the telephone number does not have a corresponding subscriber VoI device, the first subscriber VoI device may use the PSTN or a cellular network to place the call to the called subscriber. However, in the event that the called subscriber has previously provisioned a second subscriber VoI device (and, therefore, the VoI platform has a database record or other data structure associating the telephone number to the subscriber VoI device), the VoI platform may orchestrate a VoI call between the calling subscriber and the called subscriber via the respective subscriber VoI devices.

The VoI platform is configured with a device interface, a provider interface, and an internet interface. The device interface defines the mechanisms available to the subscriber VoI devices for communicating with the integration system. Because the subscriber VoI device works together with the VoI platform, functionality can be physically located as may be desired anywhere across the network. The provider interface defines the mechanisms that are available to outside programmers or service providers for introducing their services to the subscribers. The provider interface comprises a host of functional modules that register, authenticate, and manage relationships with service providers. The provider interface further comprises modules that manage the introduction, verification, and distribution of service applications and client components. The Internet interface includes one or more graphical-user interfaces (GUIs) that are configured to manage subscriber accounts and market potential services. The Internet interface also includes one or more GUIs configured to market and manage relationships and accounts with present and potential service providers. The Internet interface of the VoI platform provides both front-office and back-office solutions to subscribers, potential subscribers, service providers, and potential service providers. Front-office solutions include marketing, e-commerce, subscriber account management and similar functions. Back-office solutions include offering and accepting of business relationships with service providers, processes for registering and verifying potential services, collecting subscriber usage statistics, etc.

The subscriber VoI device is configured to receive one or more client components configured to enable add-on services that can be operative with all calls handled by the device. The client components are supplied via the data network under the control and management of the VoI platform. The client components and the device interface work together to handle and manage all services provided to the subscribers' telephones coupled to the subscriber VoI device.

While add-on services can be created by a VoI service provider or the manager of a localized data network, the above-described combination provides a mechanism for exposing consumers of both traditional landline and cellular services and VoI services to non-traditional service providers who have been prohibited from reaching these potential clients by the traditional telephone, cellular, and VoI service providers.

Having described the general operation of an exemplary integration system for providing VoI add-on services, various additional embodiments will be described with respect to FIGS. 1-9. FIG. 1 is a block diagram illustrating an embodiment of an integration system 100 that exposes subscriber VoI devices 160 to telephonic service providers 170. As illustrated in FIG. 1, VoI platform 110 resides at the core of the integration system 100. VoI platform 110 couples and manages the various functions associated with each of the provider interface 130, device interface 120, internet interface 140, and database 150. Device interface 120 defines the mechanisms by which subscriber VoI devices 160 communicate with telephonic devices via the PSTN, a cellular network, and a data network. Provider interface 130 defines the mechanisms that are available to outside programmers or service providers for introducing their services to the subscribers or users of telephonic devices coupled to the subscriber VoI devices 160. Provider interface 130 comprises a host of functional modules that register, authenticate, and manage relationships with service provider(s) 170. Provider interface 130 further comprises modules that manage the introduction, verification, and distribution of service applications and client components. Internet interface 140 manages subscriber accounts and markets potential services to present and potential subscribers. Internet interface 140 is also configured to market and manage relationships and accounts with present and potential service providers 170. Database 150 is used to store persistent operational, service provider and subscriber information.

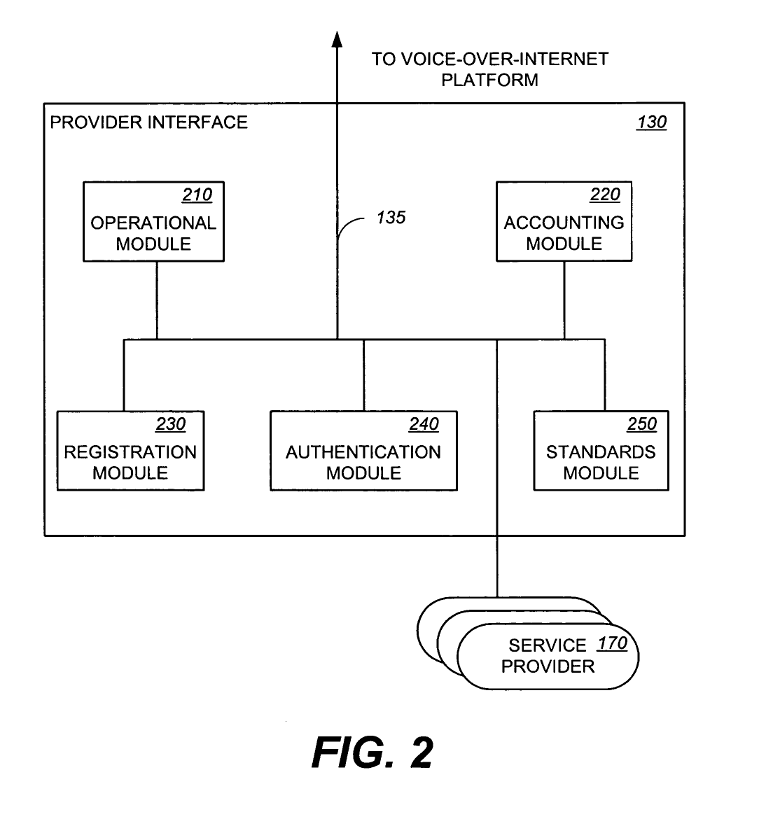

FIG. 2 is a block diagram illustrating an embodiment of the provider interface 130 of FIG. 1. As illustrated in the block diagram of FIG. 2, provider interface 130 comprises operational module 210, accounting module 220, registration module 230, authentication module 240, and standards module 250. Each of the functional modules is communicatively coupled by bus 135, which is also coupled to the VoI platform 110 and one or more service providers 170. Operational module 210 is configured to interact with the VoI platform 110 and service providers 170 and defines the rules for provisioning and managing a new telephonic service. In addition, operational module 120 receives communications from VoI platform 110 responsive to events as appropriate to various applications. Accounting module 220 interacts with VoI platform 110 to collect and distribute usage data to the one or more service providers 170. Accounting module 220 also interacts with VoI platform 110 to present, collect, and settle subscriber accounts when individual subscribers use services from multiple service providers. Registration module 230 contains one or more subscriber partner models that define the relationship between the operator of the VoI platform 110 and the one or more service providers 170. Authentication module 240 contains mechanisms for ensuring that authorized partner service providers are granted access to upload applications and or subscriber client components to the integration system 100. Authentication module 240 further authorizes access to other provider interface functions as may be appropriate for the particular service provider 170. Standards module 250 contains certification requirements and testing and compliance algorithms to ensure that a service provider application or client component will function as described and not harm the integration system 100 and the coupled PSTN and data networks.

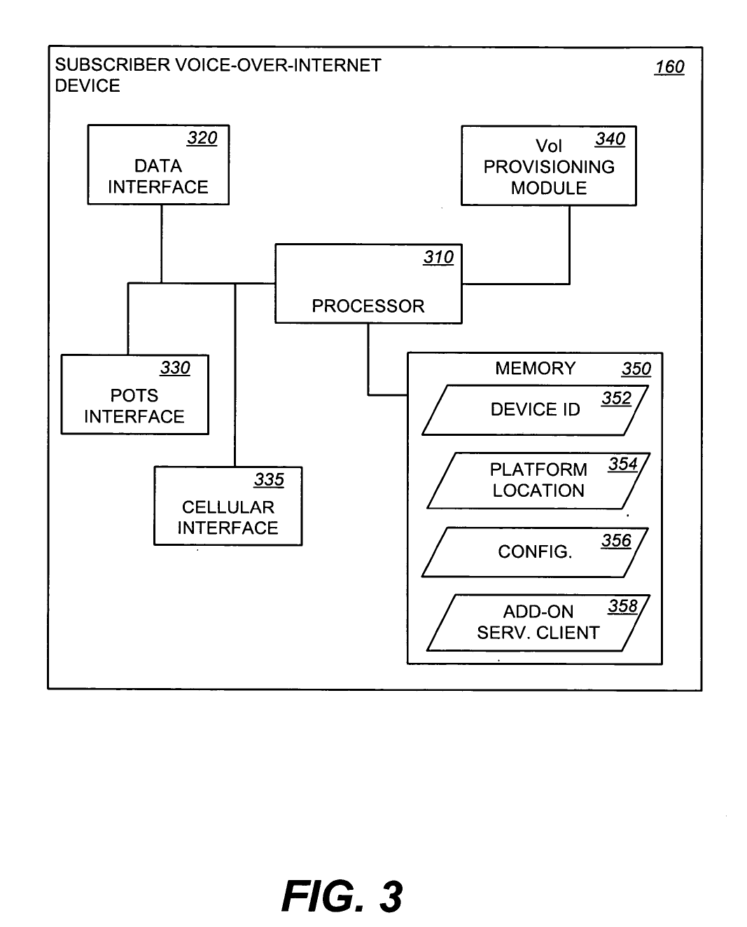

FIG. 3 is a functional block diagram of an embodiment of a subscriber VoI device 160 of the system of FIG. 1, which supports dynamic provisioning with VoI platform 110. As illustrated in FIG. 3, subscriber VoI device 160 comprises a data interface 320, a telephone interface (e.g., plain-old-telephone-service (POTS) interface 330), a cellular interface 335, a processor 310, VoI provisioning module(s) 340, and memory 350. Data interface 320 comprises a suitable interface for communicating with VoI platform 110 via a data network 110. It should be appreciated that a number of data interfaces (hardware, software, firmware) may be employed depending on the particular configuration of the data network (not shown). Data interface 320 may be configured to communicate directly with the data network or, in alternative embodiments, may merely communicate with another data interface (e.g., cable modem, DSL modem, etc.) that connects to a data network. The POTS interface 330 comprises any suitable interface for enabling a telephone (not shown) to communicate via the PSTN. Similarly, cellular interface 335 comprises any suitable interface for enabling a wireless phone (not shown) to communicate with a cellular network. Processor 310 controls the functional operation of various aspects of subscriber VoI device 160, including VoI provisioning module 340. VoI provisioning module 340 comprises the logic, functionality, etc. for automatically provisioning subscriber VoI device 160 via VoI platform 110. Subscriber VoI device 160 further comprises memory 350 which is configured with a device identifier store 352 and a platform location store 354. Device identifier store 352 includes a unique device identifier for the present subscriber VoI device 160 and may include device identifiers associated with similarly configured remotely located subscriber VoI devices that have been identified over time. Platform location store 354 includes one or more uniform resource identifiers that identify the location of the VoI platform 110. In addition, memory 350 may include one or more client components such as configuration information 356 and one or more add-on service clients 358 that enable the operation of one or more associated add-on telephonic services when a telephone is coupled and operational via the PSTN or the data network.

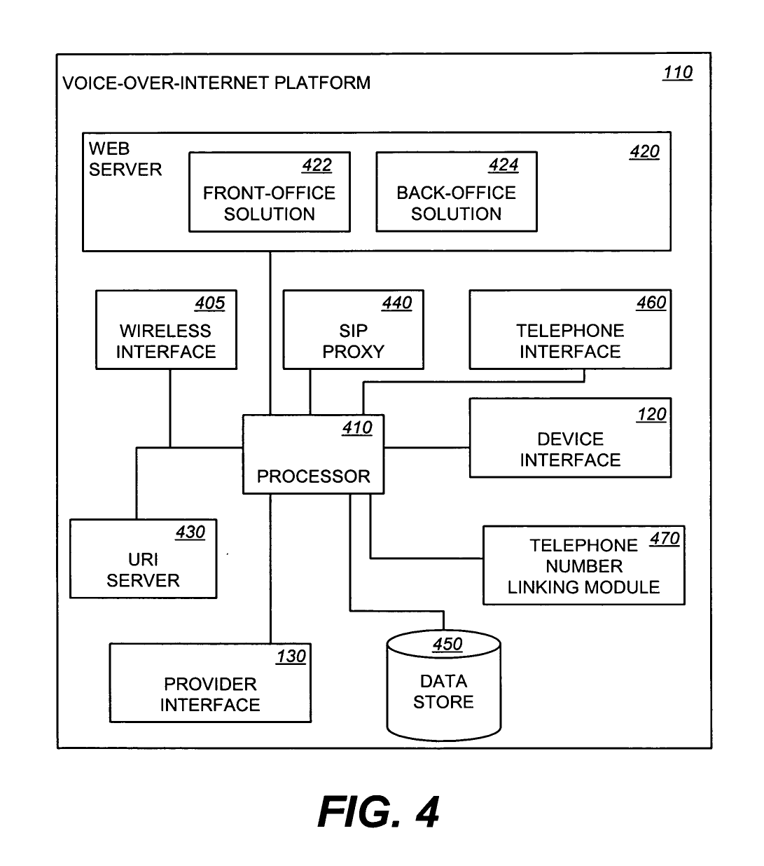

FIG. 4 is a functional block diagram illustrating an embodiment of the VoI platform 110 of FIG. 1 for providing various VoI services to subscriber VoI device(s) 160. As illustrated in the embodiment of FIG. 4, VoI platform 110 comprises device interface 120, provider interface 130, processor 410, wireless interface 405, web server 420, a uniform resource identifier (URI) server 430, SIP proxy 440, data store 450, telephone interface 460, and a telephone number linking module 470. It should be appreciated that the components of VoI platform 110 may be distributed across one or more computer systems at any number of physical locations. Furthermore, it should be appreciated that some of the functional aspects of VoI platform 110 may be located locally at customer VoI device(s) 160.

The telephone number linking module 470 comprises the logic, functionality, etc. for provisioning subscriber VoI device 160. Telephone number linking module 470 controls the process of associating, matching, linking, etc. the subscriber's existing telephone number (e.g., received via the telephone call) to the device identifier 352 (FIG. 3) associated with subscriber VoI device 160 (e.g., received via the data session)—if a transmitted session identifier received via the telephone call matches a session identifier associated with the data session. In other words, telephone number linking module 470 integrates the functions of wireless interface 405, web server 420, SIP proxy 440, telephone interface 460, URI server 430, and data store 450 to create the telephone number/device identifier pairings used to facilitate VoI communications between subscribers with similarly configured subscriber VoI devices 160. The telephone number/device identifier pairing(s) created during the provisioning process may be stored in data store 450. URI server 430 may access data store 450 in order to provide VoI services.

Web server 420 controls communications with customer VoI device(s) 160 and other data communications devices associated with subscribers, such as computers, personal digital assistants and the like via the data network or a wireless network. Web server 420 further controls communications with service providers 170. Web server 420 may support any suitable communication protocol. For instance, web server 420 may be configured as a secure server which employs the hypertext transfer transport protocol (HTTP) (secure)—HTTPS. Furthermore, some communications may be performed via HTTPS, while other communications may be performed over less secure channels, such as HTTP.

As illustrated in FIG. 4, web server 420 comprises front-office solution 422 and back-office solution 424. Front-office solution comprises one or more modules for communicating information between VoI platform 110 and the community of subscribers and potential subscribers of various telephonic services. In example embodiments, front-office solution 422 includes service, checkout, and configuration subscriber interfaces configured to enable subscribers to review, identify, purchase, and configure select services available from service provider 170 or the operator of VoI platform 110. Back-office solution 424 comprises one or more modules for communicating information between VoI platform 110 and the community of service providers and potential service providers of various telephonic services. In example embodiments, back-office solution 424 includes business relationship, service registration, service verification, subscriber usage, and billing interfaces configured to enable service providers to interact with VoI platform 110. Various modules or portions of modules of the front-office solution 422 and back-office solution 424 may be shared as may be desired.

In another embodiment, VoI platform 110 employs a session initiation protocol (SIP), which is described in detail in the following Requests for Comment (RFC) of the Internet Engineering Task Force (IETF), each of which are hereby incorporated by reference in their entirety: RFC 2543—SIP: Session Initiation Protocol; RFC 3261—SIP: Session Initiation Protocol; RFC 3262—Reliability of Provisional Responses in SIP; RFC 3263—Location SIP Servers; RFC 3264—An Offer/Answer Model with SDP; and RFC 3265—SIP-Specific Event Notification. In this embodiment, VoI platform 110 comprises a SIP proxy 440 for supporting the session initiation protocol.

Whereas data communications occur via web server 420 (and perhaps SIP proxy 440), communications with customer VoI device 160 via the PSTN are handled via telephone interface 460. Telephone interface 460 comprises any suitable interface for facilitating communication via the PSTN. Telephone interface 460 may be further integrated with IVR and touch tone functionality. Similarly, wireless interface 405 comprises any suitable interface for facilitating communication via a wireless communication network. As with telephone interface 460, wireless interface 405 may be further integrated with IVR and touch tone functionality as well. Calls enabled via telephone interface 460 may be coupled to subscriber VoI device 160 via one or more wireless networks coupled to the PSTN. Alternatively, calls may be communicated via wireless interface 405 to a cellular network or to a device coupled to the PSTN.

Uniform resource identifier (URI) server 430 provides query capabilities for compatible VoI end points (e.g., customer VoI device 160). A compatible VoI device 160 may query URI server 430 to obtain the identifier of a VoI device stored in data store 450. It should be appreciated that, in an alternative embodiment, URI server 430 and/or data store 450 may further employ the ENUM system, which is defined in RFC 2916, RFC 2782, and RFC 3403, each of which are hereby incorporated by reference in their entirety.

As known in the art, SIP proxy 440 refers to any of a variety of individual SIP-related functions, roles, etc. (or a collection thereof), which may be distributed over a communications network. By way of example, depending on the particular function, SIP proxy 440 may include any of the following, or other, client and/or server roles: proxy, registrar, back-to-back user agent, etc.

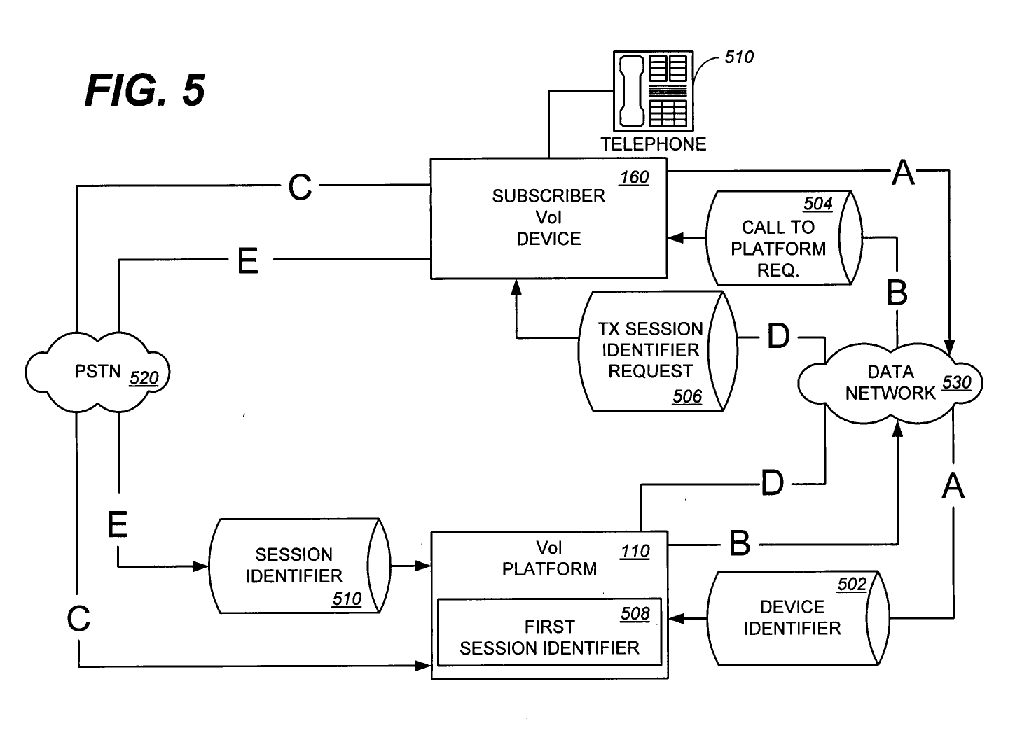

FIG. 5 is a combined block diagram and flow diagram that illustrates an embodiment of a method for provisioning subscriber VoI device 160 in the VoI platform 110 of FIG. 1. FIG. 5 illustrates the communication between subscriber VoI device 160 and VoI platform 110 during another embodiment of a method for provisioning subscriber VoI device 160. For simplicity of illustration and description only PSTN 520 and data network 530 are shown coupling VoI device 160 to VoI platform 110. Note that a cellular network (not shown) could be interposed in addition to or to replace PSTN 520 to communicatively couple VoI device 160 to VoI platform 110.

As illustrated in FIG. 5, VoI platform 110 simultaneously controls communications with subscriber VoI device 160 via PSTN 520 and data network 530. The provisioning method involves both a data session (data network 530) and a telephone call (PSTN 520). As described more below, VoI platform 110 uses both connections to associate the subscriber's existing telephone number (received via the telephone call) to a device identifier associated with subscriber VoI device 160 (received via the data session)—if a transmitted session identifier received via the telephone call matches a session identifier associated with the data session. In this manner, subscriber VoI device(s) 160 are automatically configured for the provision of VoI services with little or no demands on subscriber interaction. The data session between subscriber VoI device 160 and VoI platform 110 is represented in FIG. 5 with references lines A, B and D, while the telephone call is represented by reference lines C and E.

As illustrated by reference line A, subscriber VoI device 160 transmits a device identifier 502 to VoI platform 110 via data network 530. VoI platform 110 may authenticate subscriber VoI device 160 based on device identifier 502. Furthermore, VoI platform 110 may generate a first session identifier 508 to identify the data session with subscriber VoI device 160. VoI platform 110 provides a call-to-platform request 504 (reference line B) to subscriber VOI device 160. Call-to-platform request 504 instructs subscriber VoI device 160 to initiate the telephone call to VoI platform 110. Subscriber VoI device 160 initiates the telephone call to VoI platform 110 via PSTN 520 (reference line C). VoI platform 110 determines the existing telephone number corresponding to subscriber VoI device 160 by, for example, the ANI service mentioned above. VoI platform 110 provides a transmit-session-ID request 506 to subscriber VoI device 160 via data network 530. Request 506 instructs subscriber VoI device 160 to transmit session identifier 510 via the telephone call. If the transmitted session identifier 510 matches the first session identifier 508, VoI platform 110 associates the subscriber's existing telephone number with subscriber VoI device 160, and provisions the device for VoI services.

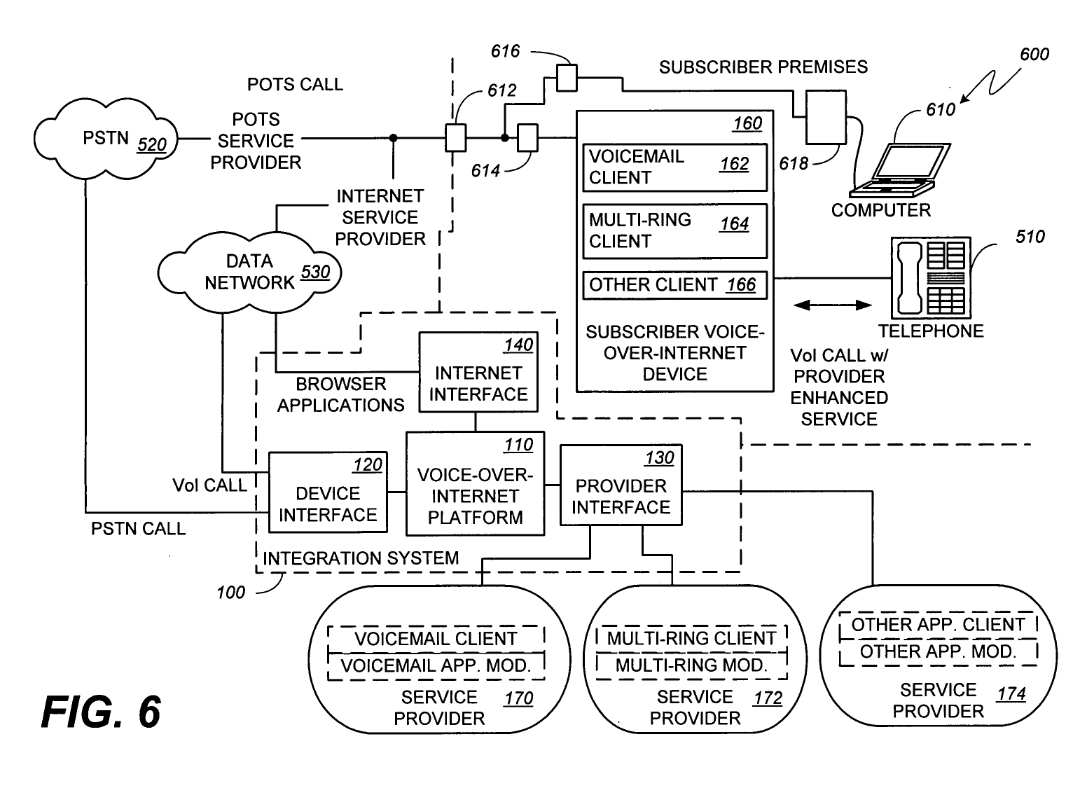

FIG. 6 is a schematic diagram illustrating an embodiment of an operational environment 600 in which the integration system 100 of FIG. 1 and the subscriber voice-over-Internet device 160 of FIG. 3 enable landline subscribers to subscribe to services from service providers 170. As noted above, a subscriber of a wireless phone service could also subscribe to add-on services from service providers 170 once a wireless network destination number is associated with VoI device 160. Operational environment 600 comprises integration system 100, which couples service providers 170, 172, 174 to subscriber VoI device 160 to expose subscribers to add-on telephonic services supplied by the service providers. As illustrated in FIG. 6, subscriber premises comprises an RJ-11 or other connection 614, which couples an existing telephone line provided by a POTS service provider to subscriber VoI device 160. Connection 616, also coupled the PSTN may provide data network service to the subscriber premises. In alternative embodiments, operational environment 600 may further comprise a base station (not shown) compatible with a wireless handset or other suitable interfaces to couple VoI device 160 to one or more cellular networks (not shown).

In the illustrated embodiment, broadband modem 618 coupled to connection 616 provides data network service to subscriber VoI device 160. Subscriber VoI device 160 is coupled to one or more telephonic handsets or telephones such as telephone 510. Subscriber premises may also have one or more devices configured to interface with data network 530 such as computer 610. Computer 610 can be used by a subscriber to interact with VoI platform 110 using one or more web browsers or other suitably configured applications to manage a subscriber account, shop for telephonic services, check on usage statistics, etc. In addition to enabling the above-mentioned account management functions, computer 610 could be configured to execute application software configured to initiate, answer, or place calls over the existing POTS telephone line.

Note that while subscriber computer 610 is located within subscriber premises, subscriber communications via data network 630 to VoI platform 110 may be enabled from devices located outside the subscriber premises. For example, a subscriber away from home equipped with a mobile device with a web browser can access and communicate with Internet interface 140 of integration system 100 over data network 530. In addition, a subscriber away from home or someone with access privileges granted by the subscriber may use an Internet connection to place a call over the existing POTS line within the subscriber premises, even when the computer 610 and subscriber are located hundreds or even thousands of miles away from home. Similarly, a subscriber presently coupled to the data network 530 may receive a call using appropriately configured software and a headset.

While the broadband data service is shown in the described embodiments as being coupled to the subscriber VoI device 160 via the telephone line, the connection to the data network is not limited to the telephone line. For example, a link to the data network may comprise a radio frequency, an infra-red or other known or later developed wireless communication media.

PSTN 520 and data network 530 couple device interface 120 of the integration system 100 to the subscriber premises via a network interface device 612. Data network 530 is also coupled to integration system 100 via Internet interface 140.

As further illustrated in FIG. 6, service providers 170, 172, and 174 are communicatively coupled to integration system 100 via provider interface 130, which was described above in association with FIG. 2. Additionally or alternatively, each of the service providers 170, 172, and 174 or potential service providers (not shown) may communicate with integration system 100 via Internet interface 140 and data network 530. These additional or alternative communications are well suited for establishing business relationships, identifying operational interfaces, communicating offers and subscriber information, transferring modules or client components, and verifying the same. In the illustrated embodiment, each of the service providers 170, 172, and 174 transfers a respective add-on service application module and/or an associated configuration or add-on service subscriber client component via the integration system to the VoI platform 110 or subscriber VoI device 160, respectively. Service provider 170 provides a voicemail application module that can be stored and made operable for telephone 510 via VoI platform 110. Service provider 170 further provides a configuration item or voicemail client 162 via integration system 100 and data network 530. Application modules and client components that are uploaded or otherwise transferred from service providers 170, 172, and 174 may include a set of executable instructions for performing designated functions. In some embodiments, application modules and client components may comprise information that is used by the subscriber VoI device 160 and VoI platform 110 to enable particular functions.

Service provider 172 provides a multi-ring application module that can be stored and made operable for telephone 510 via VoI platform 110. Service provider 172 further provides a configuration item or multi-ring client 164 via integration system 100 and data network 530. Service provider 174 provides other service application module that can be stored and made operable for telephone 510 via VoI platform 110. Service provider 174 further provides a configuration item or other add-on service client 166 via integration system 100 and data network 530. In this way, additional add-on service modules and client components may be mixed with these or otherwise add-on services that can enhance the operation of all communications made via telephone 510, whether the communication is a PSTN call or a VoI call. The provider services that can be made operable by the above described system and methods can mimic present services available from the POTS service provider that services the subscriber premises. These services may be provided by service providers at rates other than those presently available to POTS service subscribers. More importantly, as long as the modules and client components meet the operational requirements set forth by the operator of the VoI platform 110, the various provider services are limited only by the ingenuity of the various service providers and the desires of the exposed subscriber community. A service provider can use the integration system 100 to reach subscriber markets in a fraction of the time it presently takes to convince POTS service providers to investigate and decide whether to offer a new add-on service to their subscribers.

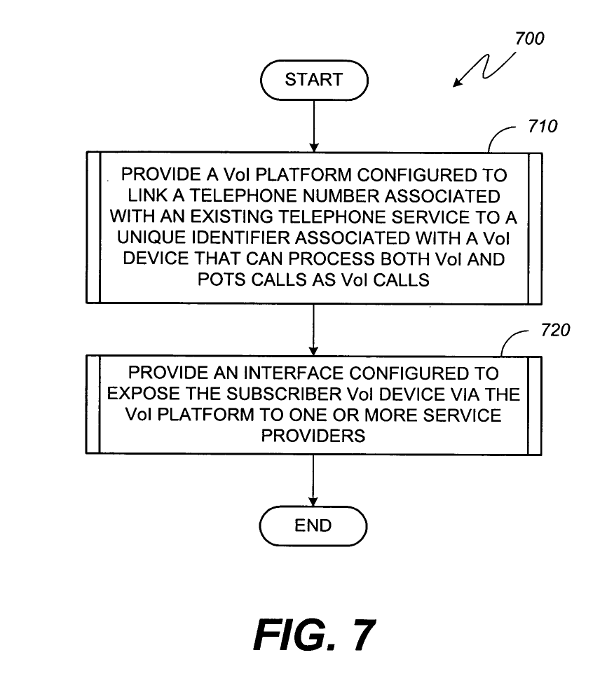

FIG. 7 is a flow diagram illustrating an embodiment of a method 700 for integrating telephonic service providers with voice-over-Internet subscribers that can be implemented by the integration system 100 of FIG. 1 and the subscriber voice-over-Internet device 160 of FIG. 3. As indicated in FIG. 7, method 700 begins with block 710 where a VoI platform 110 is provided that links a telephone number associated with an existing telephone line to a unique identifier associated with a subscriber voice-over-Internet device 160. The subscriber voice-over-Internet device 160 is configured to process POTS calls and VoI calls as voice-over-Internet calls. In block 720, an interface is provided to expose the subscriber VoI device 160 via the VoI platform 110 to one or more service providers 170.

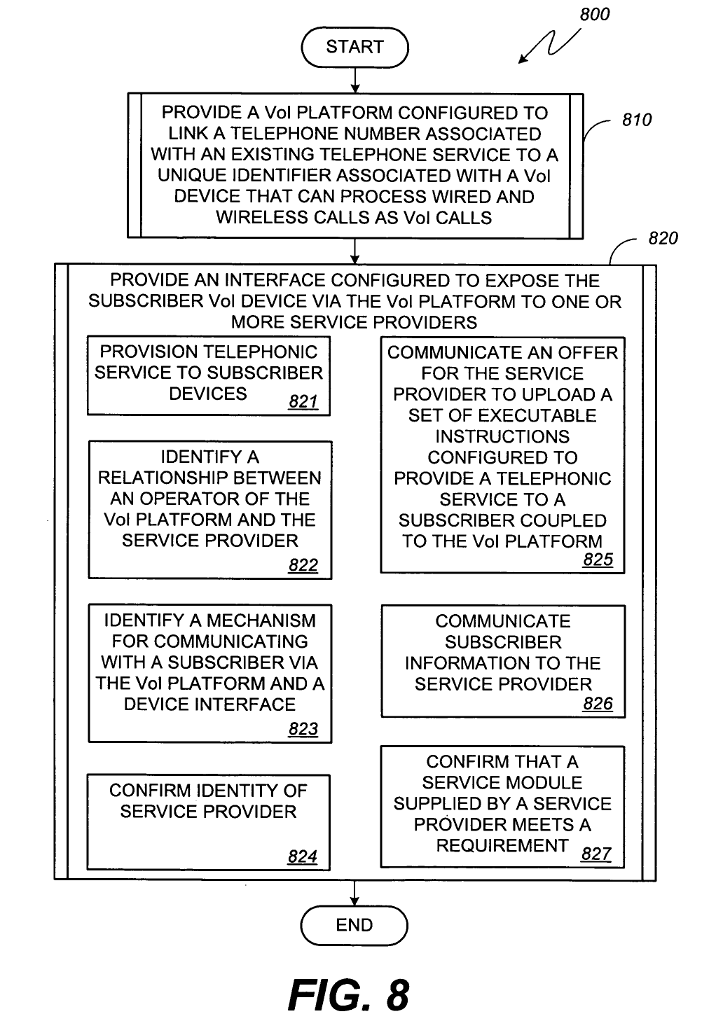

FIG. 8 is a flow diagram illustrating an alternative embodiment of a method 800 for integrating telephonic service providers 170 with voice-over-Internet subscribers that can be implemented by the integration system 100 of FIG. 1 and the subscriber voice-over-Internet device 160 of FIG. 3. As illustrated in FIG. 8, method 800 begins with block 810 where a VoI platform 110 links a telephone number associated with an existing telephone line to a unique identifier associated with a subscriber voice-over-Internet device 160. The subscriber voice-over-Internet device 160 is configured to process POTS calls and VoI calls as voice-over-Internet calls. In block 820, an interface is provided to expose the subscriber VoI device 160 via the VoI platform 110 to one or more service providers 170. As further indicated in FIG. 8, the act of exposing subscribers to service providers 170 comprises a host of functionality. For example, in block 821, the integration system 100 provisions telephonic service to subscriber devices. In block 822, the integration system 100 identifies a relationship between an operator of the VoI platform 110 and the service provider 170. In block 823, the integration system 100 identifies a mechanism for communicating with a subscriber via the VoI platform 110 and a device interface 120. In block 824, the integration system 100 communicates an offer for the service provider to upload information configured to provide a telephonic service to a subscriber coupled to the VoI platform 110. In block 826, the integration system 100 communicates subscriber information to the service provider 170. Thereafter, as indicated in block 827, the integration system 100 confirms that a service module or other information or code provided by service provider 170 meets an operational requirement or standard.

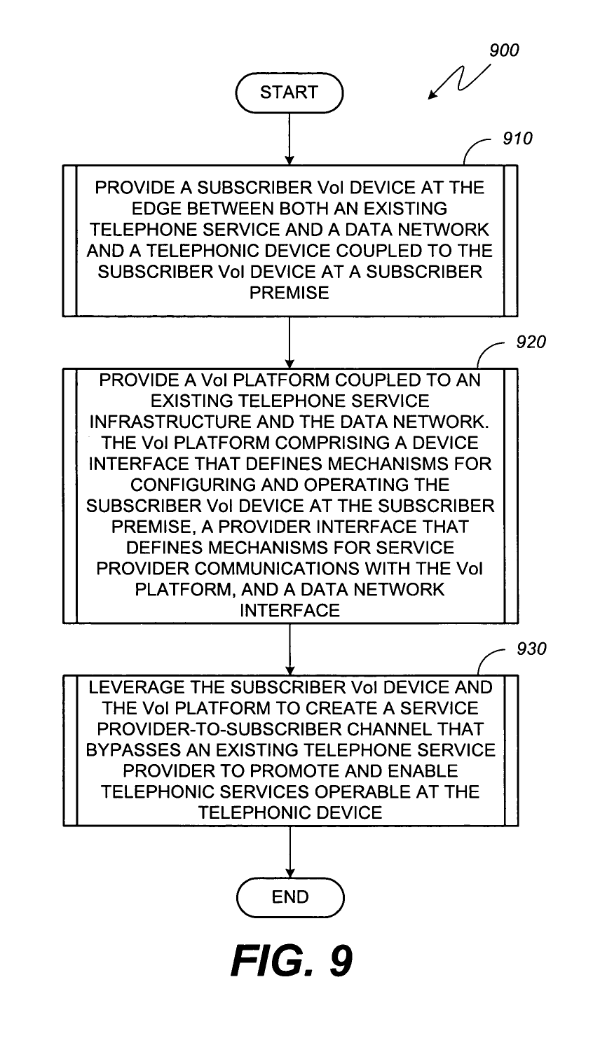

FIG. 9 is a flow diagram illustrating an embodiment of a method 900 for exposing telephonic service subscribers to service providers that can be implemented by the integration system 100 of FIG. 1 and the subscriber voice-over-Internet device 160 of FIG. 3. As illustrated in FIG. 9, method 900 begins with block 910 where a subscriber VoI device is provided at the edge between both the PSTN and a data network and a telephonic device coupled to the subscriber VoI device at a subscriber premise. In block 920, a VoI platform coupled to both the PSTN and the data network is provided. The VoI platform comprises a device interface that defines mechanisms for configuring and operating the subscriber VoI device at the subscriber premise, a provider interface that defines mechanisms for service provider communications with the VoI platform, and a data network interface. The functionality described in blocks 910 and 920 can be performed substantially simultaneously or in reverse order from that presented above. In block 930, the combination of the subscriber VoI device and the VoI platform is leveraged to create a service provider-to-subscriber channel that bypasses a POTS service provider and enables a service provider to promote and enable telephonic services operable at the telephonic device.

The flow diagrams of FIGS. 7-9 show the architecture, functionality, and operation of a possible implementation via software and or firmware associated with a host of communicatively coupled hardware devices that enables the integration of one or more add-on services from one or more service providers with a VoI platform 110 for communicating with similarly configured subscriber devices. In this regard, each block represents a module, segment, or portion of code, which comprises one or more executable instructions for implementing the specified logical function(s).

The operational software programs that may be used by the various devices of the integration system 100, as well as operational software that may be used in conjunction with browsers, telephonic devices, and applications that interface with integration system 100, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

While various embodiments of the systems and methods for integrating telephonic service providers have been described, it will be apparent to those of ordinary skill in the art that many more embodiments and implementations are possible that are within the scope of the accompanying claims. Accordingly, the systems and methods for integrating telephonic service providers are not to be restricted beyond the attached claims and their equivalents.

What is claimed is:

1. A system comprising:
a device interface configured to provide a subscriber voice-over-Internet device a communication link over an existing telephone service and a data network, wherein the subscriber voice-over-Internet device is configured to process plain old telephone service and wireless calls as voice-over-Internet calls;
a voice-over-Internet platform coupled to the device interface, the voice-over-Internet platform configured to link a telephone number associated with the existing telephone service to a unique identifier associated with the subscriber voice-over-Internet device; and
a provider interface configured to expose the subscriber voice-over-Internet device via the voice-over-Internet platform to a service provider.

2. The system of claim 1, further comprising:
an operational module configured to provision telephonic services to subscriber voice-over-Internet devices such that the telephonic services are functional when the subscriber voice-over-Internet device is communicating via a plain old telephone service call over the public switched telephone network.

3. The system of claim 2, wherein the operational module is configured to provision telephonic services to subscriber voice-over-Internet devices such that the telephonic services are functional when the subscriber voice-over-Internet device is communicating via a wireless service call.

4. The system of claim 1, further comprising:
a registration module configured to identify a relationship between an operator of the voice-over-Internet platform and the service provider.

5. The system of claim 1, further comprising:
a registration module configured to identify a mechanism for communicating with a subscriber via the voice-over-Internet platform and the device interface.

6. The system of claim 1, further comprising:
an accounting module configured to communicate an offer for the service provider to upload a set of executable instructions configured to provide a telephonic service to a subscriber communicatively coupled to the voice-over-Internet platform.

7. The system of claim 1, further comprising:
an accounting module configured to communicate subscriber information to the service provider.

8. The system of claim 1, further comprising:
an accounting module configured to communicate usage information to the service provider.

9. The system of claim 1, further comprising:
an accounting module configured to receive billing information from the service provider.

10. The system of claim 9, wherein the voice-over-Internet platform collects and presents billing information to a subscriber of services from different service providers.

11. The system of claim 1, further comprising:
an authentication module for confirming the identity of a service provider.

12. The system of claim 1, further comprising:
a standards module configured to confirm that a service module supplied by a service provider meets one or more requirements.

13. A method for integrating telephonic service providers with voice-over-Internet subscribers, the method comprising:
providing a voice-over-Internet platform configured to link a telephone number associated with an existing telephone service to a unique identifier associated with a subscriber voice-over-Internet device, wherein the subscriber voice-over-Internet device is configured to process plain old telephone service and wireless service calls as voice-over-Internet calls; and
providing an interface configured to expose the subscriber voice-over-Internet device via the voice-over-Internet platform to one or more service providers.

14. The method of claim 13, wherein providing an interface comprises provisioning telephonic services to the subscriber voice-over-Internet devices that are operational when the subscriber voice-over-Internet device is communicating via one of a plain old telephone service call over the public switched telephone network and a wireless service call.

15. The method of claim 13, wherein providing an interface comprises identifying a relationship between an operator of the voice-over-Internet platform and a service provider.

16. The method of claim 13, wherein providing an interface comprises identifying a mechanism for communicating with a subscriber via the voice-over-Internet platform and a device interface.

17. The method of claim 13, wherein providing an interface comprises communicating an offer for the service provider to upload a set of executable instructions configured to provide a telephonic service to a subscriber communicatively coupled to the voice-over-Internet platform.

18. The method of claim 13, wherein providing an interface comprises communicating subscriber information to the service provider.

19. The method of claim 13, wherein providing an interface comprises confirming the identity of a service provider.

20. The method of claim 13, wherein providing an interface comprises confirming that a service module supplied by a service provider meets one or more requirements.

21. A method for exposing telephonic service subscribers to service providers, the method comprising:
providing a subscriber VoI device at the edge between both an existing telephone service infrastructure and a data network and a telephonic device coupled to the subscriber VoI device at a subscriber premise;
providing a VoI platform coupled to both the existing telephone infrastructure and the data network, the VoI platform comprising a device interface that defines mechanisms for configuring and operating the subscriber VoI device at the subscriber premise, a provider interface that defines mechanisms for service provider communications with the VoI platform, and a data network interface; and
leveraging the combination of the subscriber VoI device and the VoI platform to create a service provider-to-subscriber channel that bypasses an existing telephone service provider and enables a service provider to promote and enable telephonic services operable at the telephonic device.

22. The method of claim 21, wherein providing a subscriber VoI device comprises selling a plug-n-play device.

23. The method of claim 22, wherein selling a plug-n-play device comprises supplying a consumer retailer with the plug-n-play device.

24. The method of claim 21, wherein providing a VoI platform comprises configuring a network accessible back-office solution.

25. The method of claim 24, wherein the accessible back-office solution defines a business process.

26. The method of claim 24, wherein the accessible back-office solution enables a service provider to register an application with the VoI platform which is presented by a front-office solution to potential subscribers to a service enabled by the application.

27. The method of claim 26, wherein a subscriber to the service is associated with the service provider to account for subscriber use of the service.

28. The method of claim 21, wherein providing an interface comprises communicating an offer for a service provider to upload a set of executable instructions configured to provide a telephonic service to a subscriber communicatively coupled to the voice-over-Internet platform.

29. The method of claim 28, wherein the set of executable instructions are communicated to the subscriber VoI device.

30. The method of claim 28, wherein the set of executable instructions are communicated to the VoI platform.
